(19) United States
(12) Patent Application Publication
(10) Pub. No.: US 2003/0069827 A1
(43) Pub. Date: Apr. 10, 2003

(54) Ticket exchange system and method of operation

(75) Inventors: Laurie E. Gathman, East Norwich, NY (US); Jack E. Haken, Danbury, CT (US)

Correspondence Address: Corporate Patent Counsel, Philips Electronics North America Corporation, 580 White Plains Road, Tarrytown, NY, 10591, US

(73) Assignee: KONINKLIJKE PHILIPS ELECTRONICS N.V.

(21) Appl. No.: 09/970,910

(22) Filed: Oct. 4, 2001

(51) Int. Cl. G06F 17/60

(52) U.S. Cl. 705/37

(57) ABSTRACT

An electronic ticket exchange system and method of operation. Tickets for public-facility events are issued by the facility's electronic ticket control system, which maintains a database for storing ownership information regarding each electronic ticket. When the electronic ticket control system receives a ticket exchange request message from a virtual ticket device on which one or more electronic tickets are stored, it compares the conditions of exchange in the request with ownership information in the database to determine if a match can be found. If so, the parties are notified through a message to their virtual ticket devices and, upon confirmation, the exchange is effected by updating the electronic ticket information in each of the virtual ticket devices and also in the electronic ticket control system database.

### CROSS-REFERENCE TO RELATED APPLICATIONS

The present invention is related to those disclosed in the following U.S. patent applications:

1. Ser. No. [Docket No. US 010493], filed concurrently herewith, entitled “SELLING BEST AVAILABLE SEATS AT A PUBLIC FACILITY”;

2. Ser. No. [Docket No. US 010494], filed concurrently herewith, entitled “SYSTEM FOR DISPLAYING PERSONAL MESSAGES AT A PUBLIC FACILITY AND METHOD OF DOING BUSINESS”;

3. Ser. No. [Docket No. US 010495], filed concurrently herewith, entitled “SYSTEM AND BUSINESS FOR OFFERING SEAT UPGRADES TO PATRONS AT A PUBLIC FACILITY”;

4. Ser. No. [Docket No. US 010496), filed concurrently herewith, entitled “BUSINESS METHOD AND SYSTEM FOR COMMUNICATING PUBLIC-FACILITY STATUS INFORMATION THROUGH A VIRTUAL TICKET DEVICE”;

5. Ser. No. [Docket No. US 010498], filed concurrently herewith, entitled “PUBLIC VENUE AUCTION SYSTEM AND METHOD OF OPERATION”;

6. Ser. No. [Docket No. US 010499], filed concurrently herewith, entitled “SYSTEM AND METHOD FOR SELLING GOODS TO CUSTOMERS OF A PUBLIC FACILITY”; and

7. Ser. No. [Docket No. US 010500], filed concurrently herewith, entitled “SYSTEM AND METHOD FOR SELLING IMAGE DISPLAY TIME TO CUSTOMERS OF A PUBLIC FACILITY”.

The above applications are commonly assigned to the assignee of the present invention. The disclosures of these related patent applications are hereby incorporated by reference for all purposes as if fully set forth herein.

### TECHNICAL FIELD OF THE INVENTION

The present invention is directed to public-facility electronic ticket control systems and, more specifically, to a system and method for permitting the exchange of electronic tickets between patrons of the facility using virtual ticket devices.

### BACKGROUND OF THE INVENTION

Large public entertainment facilities, such as convention centers, concert halls, stadiums, sports arenas, and the like, are the civic centers of many communities and are important sources of revenue and employment. Quite often, public facilities are funded by taxpayers in order to attract or at least retain sports franchises, and to attract tourists and conventions. The large sums invested in public entertainment facilities make it essential to maximize the revenue derived from such facilities and to minimize their operating costs.

However, large public facilities tend to be labor intensive operations. A typical sports facility requires a large number of gate attendants, ticket agents, ushers, concession stand operators, shop vendors, and security officers, and the like. Many new sports facilities also employ waiters and waitresses who take orders from, and serve food and drink to, customers at their seats. Facility operators use labor-saving technology wherever possible in order to offset the high labor costs associated with large public facilities.

In addition to cutting costs, facility operators also try to increase revenue in different ways. The principle sources of revenue are ticket sales, concession stands, and vendor shops. Promotions are frequently offered in order to increase sales and many public facilities do not permit patrons to bring their own food and drink into the venues. And facility operators are increasingly seeking new technology to provide new and enjoyable services to customers and thereby increase attendance and revenue.

One potential revenue-enhancing service is facilitating the resale and exchange of previously-purchased tickets. Previously frowned upon, the resale of facility tickets for current-market value is currently gaining acceptance. Rather than pricing local fans out of the market, a system of permitted ticket exchange is now seen to allow purchasers of tickets—who often purchased at risk of declining value—take advantage of conditions that raise values instead. The ability to resell them may make tickets more, not less, valuable given that facility patrons can expect at least the possibility that the loss from unused tickets sold at below face value will be offset by gains from selling them when prices rise.

Although paper tickets can generally be bought, sold, and exchanged among facility patrons with relative ease, local laws frequently discourage doing so overtly, and also frustrate efficient exchanges because open advertising and bidding is not allowed. These proscriptive measures are often enacted to address concerns of fraud, sharp dealing, and lost facility revenue; issues that are admittedly difficult to address in a paper-ticket system. Even where proscriptive laws do not exist, matching willing buyers and sellers is very inefficient in a paper ticket system, especially where tickets are held until near the time of the event. Not infrequently, patrons will discover that they cannot attend an event only days, even hours, prior to its commencement. Such patrons are often left with no alternative but to wait outside the public facility hoping to there find someone with whom to exchange even though there often exist other patrons who would gladly exchange tickets if they knew of the situation.

Paper-ticket systems have limitations. Needed is a way to issue tickets for events at public facilities that overcome these limitations and allow the efficient exchange of previously-purchased ticket that not only presents a revenue-raising opportunity to the facility operator, but also allows the exchange process to be monitored for fraud and sharp dealing. The present invention provides just such a system and method.

### SUMMARY OF THE INVENTION

To address the above-discussed deficiencies of the prior art, it is a primary object of the present invention to provide a public-facility ticket exchange system for trading and reselling electronic tickets distributed to virtual ticket devices by an electronic ticket control system. A virtual ticket device is a portable computer system that delivers virtual tickets for sports events, theater, concerts, and the like, together with various services and methods of doing business which are linked to and implemented through the virtual ticket device.

In its simplest form, the virtual ticket device is an existing smart telephone or cellular communication-enabled personal digital assistant (PDA), such as a PALM PILOT™ or a VISOR™ electronic organizer. A dedicated virtual ticket device could also be used. A customer who wishes to attend an event purchases admission in any conventional manner (e.g., by telephone from a ticket service, in person at a box office, via the Internet). The ticket vendor sends an encrypted admission authorization record over a wireless channel or a wireline channel to the virtual ticket device, where it is stored as a virtual electronic ticket.

It will be recognized that the virtual ticket device serves multiple functions to its user. There are clear synergies between many of these functions; for example the communications functions of the device may be enhanced when the customer's seat location and entry time are known and stored in the system. Nevertheless many aspects of the present invention remain new and useful even when the customer is admitted to the facility with a paper ticket or in another conventional manner and for this reason, the term “virtual ticket device” as used in this patent specification and the claims which follow, is not limited or restricted to a device which is actually used or even programmed to authorize a customer's admission to the facility.

The encrypted admission authorization record may include, for example, information that identifies the date and location of the event, the seat number, price paid, and the like. The encrypted admission authorization record also may include uniquely encrypted information which may be used in a conventional manner to authenticate that the record is genuine. The same information is preferably stored in a central database which is accessible by the event operator or his service provider. The record in the database should preferably also include the telephone number or wireless address of the virtual ticket device so that contact with the virtual ticket device may be established at a later time.

Entry point terminals are provided at the entrances of the public entertainment facility which read at least the encrypted authentication information from the virtual ticket device and authorize the customer to enter the event. The entry point terminals read the authentication information over a very short range wireless (RF) channel or infrared (IR) channel, or via a dedicated interface slot coupled to a wireline channel to prevent eavesdropping and spoofing of the process. For example, the virtual ticket device may be programmed to display the data either as a string of characters (e.g., serial number) or a bar code on its LCD display and the displayed information can be optically scanned in a chamber of the entry point terminal.

Further, according to an advantageous embodiment of the present invention, the system includes a database for storing ticket information relating to tickets that have already been purchased. When a patron indicates that such a ticket is available for exchange, the ticket information relating to that ticket is retrieved. An appropriate listing on a public ticket exchange board is made, or the system simply waits to receive a request corresponding to the exchangeable ticket. When two ticket exchange requests have been received that indicate an exchange is possible, the electronic ticket control system notifies the parties subsequent to receiving any necessary confirmation, the electronic ticket control system sends a message to each virtual ticket device to update the electronic tickets as appropriate. If permitted, electronic tickets may be exchanged for consideration other than other electronic tickets, including money or facility credit. Note that herein, the term “exchange” will apply to and include any of these, or similar transactions.

In an alternate embodiment, a potential ticket exchanger specifies certain conditions of exchange for a desired ticket exchange. For example, a patron may communicate a desire to obtain tickets to box seats for any event in late July. While this information is stored in a database associated with the electronic ticket control system, the system may also perform a pre-defined algorithm to locate qualifying electronic tickets (those meeting it the stated conditions). The owners of these tickets, or a selected subset of them, may then be notified.

### BRIEF DESCRIPTION OF THE DRAWINGS

FIG. 1 is a plan diagram of an entertainment venue in which an electronic ticket control system according to the principles of the present invention may be deployed;

FIG. 2 illustrates a virtual ticket device which is capable of interacting with an electronic ticket control system according to the principles of the present invention;

FIG. 3 illustrates a virtual electronic ticket displayed on the virtual ticket device in FIG. 2 according to one embodiment of the present invention;

FIG. 4 illustrates an electronic ticket control system according to one embodiment of the present invention; and

FIG. 5 is a flow diagram illustrating the operation of the electronic ticket control system and the virtual ticket device according to one embodiment of the present invention;

FIG. 6 illustrates selected portions of electronic ticket control system 400 that enables patrons of exemplary public facility 100 to participate in a ticket exchange according to one embodiment of the present invention; and

FIG. 7 is a flow chart illustrating a method of enabling ticket exchanges according to an embodiment of the present invention.

### DETAILED DESCRIPTION OF THE INVENTION

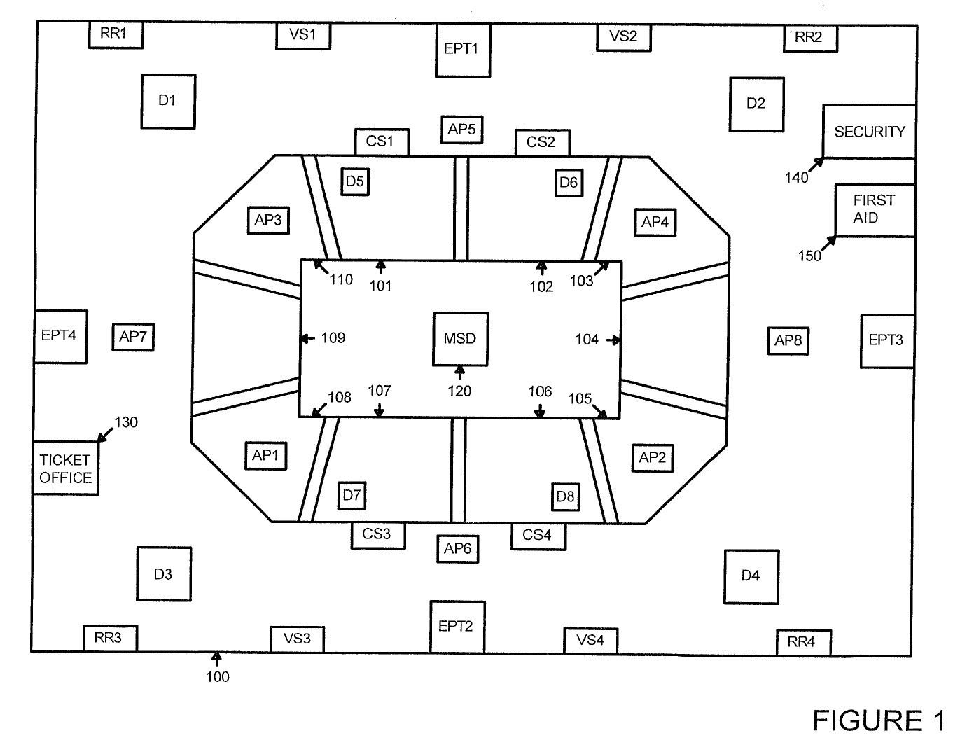

FIG. 1 is a plan view of public facility 100 in which an electronic ticket control system according to the principles of the present invention may be deployed. Public facility 100 is representative of any public venue that is capable of holding a large audience. Thus, public facility 100 may include a football or baseball stadium, a basketball or hockey arena, a large concert hall, a convention center, and the like. As used herein and for the purpose of determining the scope of the claims of the present invention, the term “public facility” may include any controlled-access location to which people may be admitted by means of an electronic ticket control system and should not be construed to exclude facilities that are privately owned or that are open only to selected portions of the general public. In fact, public facility 100 may include controlled-access private clubs and private buildings, and even controlled-access forms of transportation, such as trains, planes, cruise ships, and the like. However, for the purpose of simplicity in explaining the principles of the present invention, it shall be assumed that public facility 100 is a sports facility.

Public facility 100 comprises a plurality of seating areas, including exemplary seat sections 101-110, that surround a playing area (e.g, hockey rink, basketball court, indoor track, or the like). Suspended over the playing area is multi-sided display (MSD) 120, which has large display screens on four sides. The seating areas are surrounded by an exterior promenade area that contains a plurality of concession stands (CS), including four exemplary concession stands labeled CS1, CS2, CS3 and CS4. The promenade area also includes a number of rest rooms (RR), including exemplary rest rooms labeled RR1, RR2, RR3 and RR4, and numerous vendor shops (VS), including exemplary vendor shops labeled VS1, VS2, VS3 and VS4. Finally, the promenade area contains ticket office 130, security office 140, and first aid station 150.

Electronic displays of various types are positioned throughout public facility 100. In the promenade area, displays D1, D2, D3 and D4 enable patrons at the concession stands or vendor shops, or waiting in rest room lines, to view the sporting event that is ongoing in the playing area. In the seating area, patrons can view displays D5, D6, D7 and D8, which typically display advertisements, scores of other sporting events, player statistics, audience greetings, and the like. As used herein and for the purpose of determining the scope of the claims of the present invention, displays D1-D8 may be any type of conventional display devices, including electronic signs, conventional sized television sets, large screen television sets, and multisided television displays, that generally may be viewed by at least some of the customers of public facility 100 and do not include non-public displays which are viewed by employees of public facility 100.

For example, each one of displays D1, D2, D3 and D4 may be an elevated multisided display system having three or four sides, wherein each side contains a large screen video display. Also, in an exemplary embodiment, one or more of displays D5-D8 in the seating area may be a conventional television set that is disposed in a luxury box of public facility 100.

Each of entry point terminals EPT1, EPT2, EPT3 and EPT4 is disposed next to one of four entrances to public facility 100. EPT1, EPT2, EPT3 and EPT4 are capable of detecting and registering the virtual electronic tickets used by customers of public facility 100. EPT1-EPT4 read at least the encrypted authentication information from the virtual ticket device and authorize the customer to enter public facility 100. Each one of EPT1, EPT2, EPT3 and EPT4 registers the admission of each virtual electronic ticket by any one of several conventional technologies. For example, one or more of EPT1, EPT2, EPT3 and EPT4 may comprise an optical scanner that scans a bar code or a serial number displayed on the display of a virtual ticket device that stores each virtual electronic ticket. Alternatively, one or more of EPT1, EPT2, EPT3 and EPT4 may comprise a radio frequency transceiver that establishes an RF link (such as a Bluetooth connection), or an infrared (IR) transceiver that establishes an IR link, that transfers the virtual electronic ticket information from the virtual ticket device used by the customer to the entry point terminal. In still another embodiment, one or more of EPT1, EPT2, EPT3 and EPT4 may contain a slot or a similar hardware interface into which a virtual ticket device may be inserted or engaged in order to transfer the virtual electronic ticket information via a wireline connection.

Additionally, a number of wireless or wireline access points (APs) are distributed throughout the seating area and the promenade area of public facility 100. Exemplary access points labeled AP1-AP8 are shown in FIG. 1. According to an advantageous embodiment of the present invention, EPT1-EPT4 may function both as access points and as entry point terminals. AP1-AP8 provide communication channels that permit the virtual ticket devices used by customers to communicate with the electronic ticket control system associated with public facility 100. According to an advantageous embodiment of the present invention, AP1-AP8 are radio frequency transceivers similar to the base stations of a cellular telephone system that provide two-way radio frequency (RF) communication links with virtual ticket devices within public facility 100. Preferably, AP1-AP8 have a hand-off capability that allows a customer to roam 20 throughout public facility 100 without losing communication with the electronic ticket control system. Advantageously, this allows the electronic ticket control system to continually track the location of each virtual ticket device in public facility 100.

However, in alternate embodiment of the present invention, one or more of AP1-AP8 may be physical interface slots into which virtual tickets devices may be inserted. For example, each seat in public facility 100 may be provided with an interface slot (similar to an electronic cradle) that may mate with a virtual ticket device. A wireline connection to each such interface slot enables each virtual ticket device to communicate with the electronic ticket control system. Furthermore, according to an advantageous embodiment of the present invention, exterior access points may be disposed in the areas outside of public facility 100 in order to communicate with customers as they are nearing, and before they enter public facility 100.

Access points, such as AP1-AP8 and EPT1-EPT4, may be used to provide a variety of user-friendly services to the patrons of public facility 100. When a customer is near, but not yet admitted to, public facility 100, the access points may transmit useful information to the virtual ticket device used by the customer, including directions to the nearest entrance, advice as to which entrance has the shortest waiting line, promotional items available at vendor shops and concession stands, and the like. After the customer has been admitted to public facility 100, the access points may provide the virtual ticket device real time directions from her present location to her assigned seat, to particular concession stands or vendor shops, to rest rooms, or to other service areas. Information on which concession and service has the shortest line can also be provided.

Using the access points, the facility operator can know in real time how many admitted customers are at their seats and may schedule the start of programs on this basis. The customer can place orders for food and promotional items via the access points using the virtual ticket device and the vendors can deliver these goods to her present location. The access points and the virtual ticket device can also be used to authenticate the identity of the customer before the goods are turned over to her.

The facility operator may use the access points to communicate information to the virtual ticket devices about available seating upgrades. These could be based on the real time location of the customer. For example, an access point may transmit to the virtual ticket device the message: “Two seats are available in the section in front of you. Would you like to move there for an additional $10?” If the virtual ticket device has capability for broadband communication and a reasonably high quality display, this could be supplemented with video promotions, such as: “Here's what the last home run looked like from section 110. Would you like to upgrade your seat and move there?” In accordance with an embodiment of the present invention, ticket-holding patrons can also exchange tickets with other patrons by using their virtual ticket device to communicate with the patron ticket exchange function of the facility electronic ticket control system.

Customers can also use their virtual ticket devices to signal their present location within public facility 100 to friends and to locate lost family members. A network of entry point terminals may be used within public facility 100 to authorize admission to various areas such as preferred seating sections, clubs, luxury boxes, reserved rest rooms, priority parking lots, and the like. Additionally, automated cameras in public facility 100 may be used to photograph the customers during an event and the photographs can later be identified with groups of virtual tickets and offered for sale to the customers. In the case of accidents or disruptions, the location information can be used to contact potential witnesses. Additionally, seating and purchase information can be used for directed post-event marketing, which can be communicated directly to the virtual ticket device.

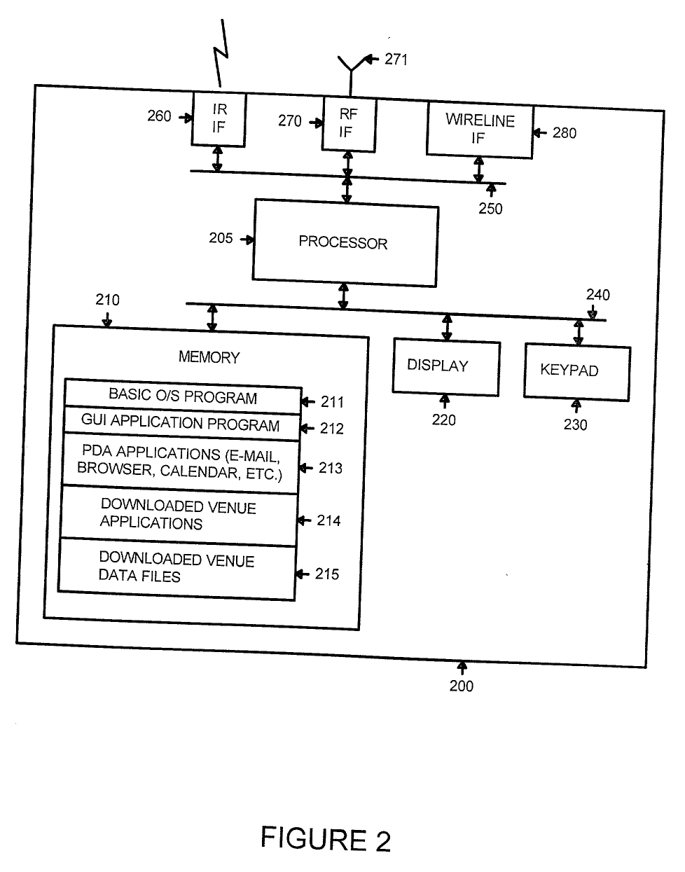

FIG. 2 illustrates virtual ticket device 200, which is capable of interacting with an electronic ticket control system according to the principles of the present invention. Virtual ticket device 200 comprises processor 205, memory 210, display 220, keypad 230, and one or more communication interfaces, including infrared (IR) interface (IF) 260, radio frequency (RF) interface (IF) 270, and wireline interface (IF) 280. Processor 205, memory 210, display 220, and keypad 230 are coupled to, and communicate via, system bus 240. Processor 205, memory 210, display 220, and keypad 230 are coupled to, and communicate via, input/output (I/O) bus 250.

Processor 205 controls the overall operation of virtual ticket device 200 by executing basic operating system (O/S) program 211 in memory 210. Memory 210 also stores graphical user interface (GUI) application program 212, a plurality of personal digital assistant (PDA) applications 213, downloaded venue applications 214, and downloaded venue data files 215. PDA applications 213 may include, for example, an e-mail application, a browser application, a calendar application, and the like.

In the illustrated embodiment, virtual ticket device 200 contains three external communication interfaces, namely, infrared interface 260, radio frequency interface 270, and wireline interface 280. However, not all of these external communication interfaces are necessary to the operation of the invention. For example, in an advantageous embodiment of the present invention, virtual ticket device 200 may only contain wireline interface 280 and RF interface 270. Virtual ticket device 200 may be adapted for insertion into a cradle device that plugs into wireline interface 280 and provides virtual ticket device 200 with electrical power for recharging a battery (not shown) in virtual ticket device 200. When virtual ticket device 200 is plugged into a cradle device, applications and data may be downloaded or uploaded via wireline interface 280.

For example, in an advantageous embodiment of the present invention, virtual ticket device 200 may be a wireless enabled electronic organizer, such as a Palm VII™ organizer. As those skilled in the art are aware, a Palm VII™ organizer (or an equivalent appliance) is capable of communicating via a wireless interface (such as RF interface 270) and may be mounted in a cradle device that provides wireline communication and power supply voltages to the organizer.

Processor 205 executes GUI application program 212 in order to interact with the operator of virtual ticket device 200 via keypad 230 and display 220. Normally, GUI application program 212 enables processor 205 to execute PDA applications 213 stored in memory 210. One of these applications may include a browser application that allows virtual ticket device 200 to access via RF interface 270 or wireline interface 280 a website for a ticket agency in order to purchase a virtual electronic ticket to an event at public facility 100. When a virtual electronic ticket is purchased in this manner, the virtual electronic ticket and other useful applications and data files may be downloaded from the ticket agency website to virtual ticket device 200 and stored in downloaded venue applications 214 and downloaded venue data file 215.

Downloaded venue data file 215 may be used to store such information as the virtual electronic ticket, electronic maps of public facility 100, text information related to concession stands and vendor shops, and text information related to security and first aid at public facility 100. Downloaded venue applications 214 may include one or more applications executed by processor 205 when the customer is at public facility 100. In particular, downloaded venue applications 214 may include a communication application that enables processor 205 to control the operation of RF interface 270 and wireline interface 280 such that virtual ticket device 200 is capable of communicating with access points AP1-AP8 and entry point terminals EPT1-EPT4 at public facility 100. For example, the communication application may configure RF interface 270 in virtual ticket device 200 to use the operating frequency channels and medium access control (MAC) layer protocols used by AP1-AP8 and EPT1-EPT4.

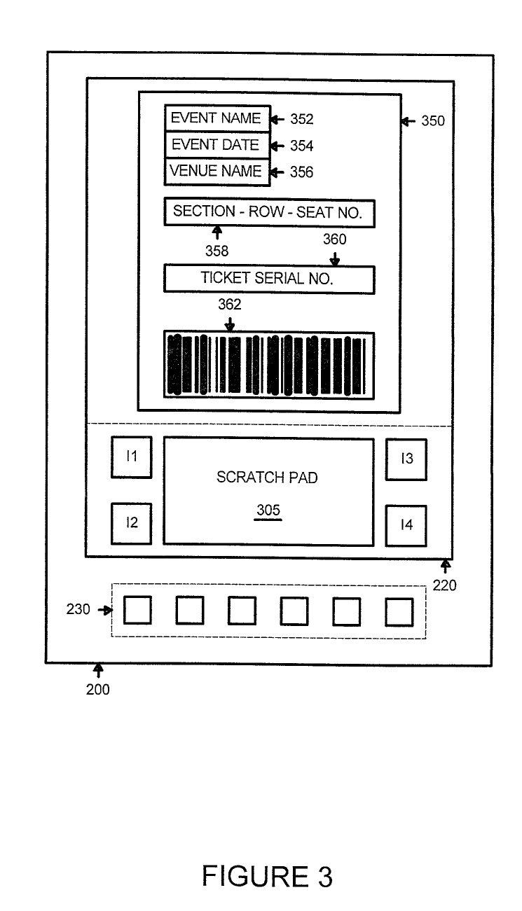

FIG. 3 illustrates virtual electronic ticket 350 displayed on virtual ticket device 200 according to one embodiment of the present invention. Virtual ticket device 200 comprises display 220, and keypad 230. The lower portion of display 220 contains scratch pad 305 and a plurality of icons, namely icons I1, I2, I3, and I4. The upper portion of display 220 contains virtual electronic ticket 350. Virtual electronic ticket 350 comprises event name field 352, event date field 354, venue name field 356, seating information field 358, ticket serial number field 360, and bar code field 362.

The operator of virtual ticket device 200 may use a stylus or a similar device to select icons I1, I2, I3 or I4 and thereby launch one or more of PDA applications 213 in memory 210. Additionally, the operator may use the stylus to enter text or numbers in scratch pad area 305 when executing one of PDA applications 213 that permits the entry of text data. Additionally, the buttons in keypad 230 may be used to select icons or to perform functions such as scroll up, scroll down, scroll left, scroll right and the like.

When the customer approaches or enters public facility 100, the customer turns on virtual ticket device 200 and launches the communication application in downloaded venue applications 214 that allows virtual ticket device 200 to communicate with entry point terminals EPT1-EPT4 and access points AP1-AP8 in public facility 100. The communication application may be launched automatically simply by selecting virtual electronic ticket 350 that has been downloaded and stored in downloaded venue data files 215. Event name field 352 contains the name of the event occurring in public facility 100, such as “New York Knicks vs. Indiana Pacers.” Event date field 354 contains the date on which the event is occurring, such as “Nov. 13, 2001.” Venue name field 356 contains the name of public facility 100, such as “Madison Square Garden.” Seating information field 358 contains the section, row and seat number information associated with virtual electronic ticket 350.

If the entry point terminal contain an optical scanner, the optical scanner may scan one or both of ticket serial number field 360 and bar code field 362. An optical character recognition application may be used to read the serial number appearing in ticket serial number field 360. A conventional bar code scanner device may read the bar code in bar code field 362. In either event, when virtual electronic ticket 350 is identified, the entry point terminal accesses the data base associated with the electronic ticket control system associated with public facility 100 and, if virtual electronic ticket 350 is properly authenticated, permits the customer to enter public facility 100. The entry point terminal may produce a visible or audible signal approving entry by the customer. Alternatively, if virtual electronic ticket 350 is not authenticated, the entry point terminal may generate an audible or visual alarm alerting a nearby gate attendant that the customer should not be admitted to public facility 100.

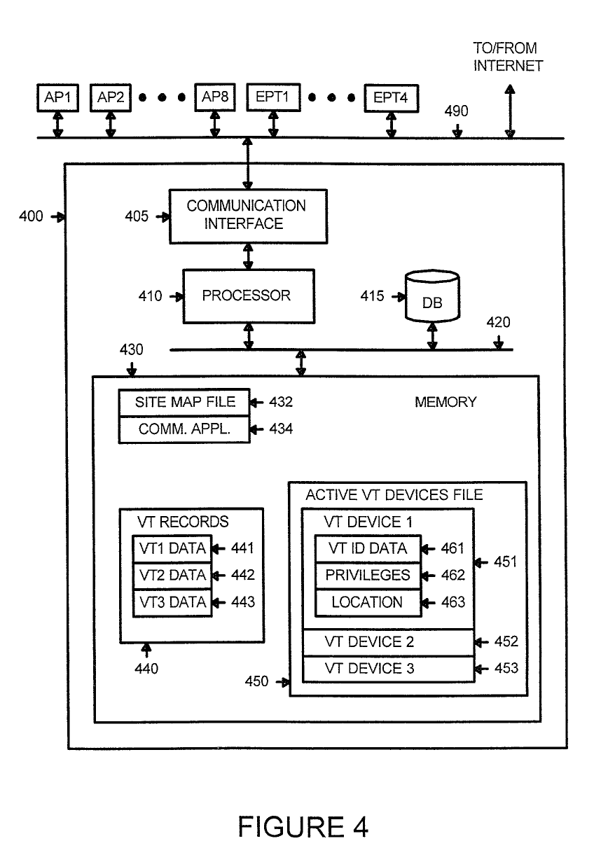

FIG. 4 illustrates electronic ticket control system 400 according to one embodiment of the present invention. Electronic ticket control system 400 comprises communication interface 405, processor 410, database (DB) 415, and memory 430. Processor 410, database (DB) 415, and memory 430 are coupled to, and communicate via system bus 420. Communication interface 405 has an external network connection that interfaces with network bus 490. Communication interface 405 enables processor 410 to communicate with exemplary access points AP1-AP8 and exemplary entry point terminals EPT1-EPT4. Communication interface 405 also enables processor 410 to communicate with remote servers and other devices via the Internet.

Memory 430 stores site map file 432, communication application program 434, virtual ticket records 440, and active virtual ticket devices file 450. Virtual ticket records 440 contains a plurality of virtual ticket data records 441-443, which are arbitrarily labeled VT1 DATA, VT2 DATA and VT3 DATA, respectively. Virtual ticket records 440 comprises a master list of all virtual tickets that were sold to the particular event occurring at public facility 100. Each virtual ticket data record 441-443 contains the serial number or bar code of each virtual ticket, the section and seat number information associated with each virtual ticket, payment information (optionally), the privileges associated with each virtual ticket, and the like. The virtual tickets that are received from the virtual ticket devices are compared to the virtual ticket data in virtual ticket records 440 before admitting each customer to public facility 100.

Virtual ticket data records 441-443 may be downloaded via the Internet from a server associated with a ticketing agency that sells tickets to events held at public facility 100. Alternatively, electronic ticket control system 400 itself also may function as a server that potential customers may access over the Internet in order to buy virtual tickets. As each virtual ticket is sold to a potential customer, electronic ticket control system 400 creates and stores a corresponding virtual ticket data record 441 and transmits the electronic virtual ticket over the Internet to the customer.

Active virtual ticket devices file 450 contains virtual ticket device records 451-453 associated with virtual ticket devices that are in active communication with electronic ticket control system 400. After each received virtual ticket is received and authenticated, a virtual ticket device record for the corresponding virtual ticket device that has been admitted is created in active virtual ticket device file 450. Virtual ticket device records 451453 are arbitrarily labeled VT DEVICE 1, VT DEVICE 2, and VT DEVICE 3, respectively. Exemplary virtual ticket device record 451 comprises virtual ticket (VT) identification (ID) data field 461, privileges field 462, and location field 463. Database 415 normally holds the master copies of all of the information stored in memory 430. However, the information in database 415 is loaded into memory 430 for processing by processor 410.

Site map file 432 contains electronic map data that may be downloads to virtual ticket device 200 in order to display the location of the seat corresponding to a particular virtual ticket. The electronic map data also may illustrate the locations of the rest rooms, concession stands, vendor shops, ticket office 130, security office 140 and first aid station 150. Virtual ticket identification field 461 identifies the virtual ticket associated with virtual ticket device record 451. Privileges field 462 indicates the restricted areas in public facility 100 to which the virtual ticket gains admission. For example, privileges field 462 may indicate which restaurants and luxury boxes the user of a particular virtual ticket may enter. Finally, location field 463 indicates the current location of virtual ticket device 200.

Communication application program 434 comprises a communication protocol that may be transmitted to virtual ticket device 200 in order to permit virtual ticket device 200 to communicate with the access points and entry point terminals in public facility 100. According to one embodiment of the present invention, a user of virtual ticket device 200 may download communication application program 434 from electronic ticket control system 400 via the Internet before going to public facility 200. Alternatively, electronic ticket control system 400 may initially use a standard protocol to establish a simple connection with virtual ticket device 200 and then may download communication application 434 is order to establish a more advanced communication link.

For example, if EPT1 and virtual ticket device 200 are both Bluetooth-enabled systems, EPT1 may establish an initial Bluetooth connection with virtual ticket device 200 as the user of virtual ticket device 200 approaches EPT1. After the Bluetooth connection is established, EPT1 may download communication application program 434 to virtual ticket device 200. Thereafter, virtual ticket device 200 may use communication application program 434 to establish wireless LAN (e.g., IEEE 802.11) connections with one or more of EPT1-EPT4 and AP1-AP8 as the user of virtual ticket device 200 roams around public facility 100.

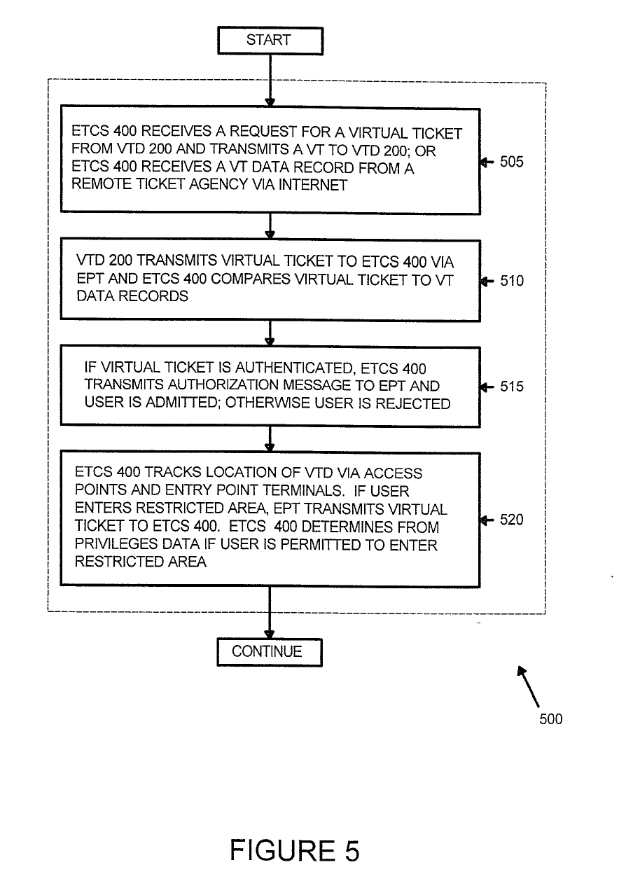

FIG. 5 depicts flow diagram 500, which illustrates the operation of electronic ticket control system 400 and portable virtual ticket device 200 according to one embodiment of the present invention. Initially, electronic ticket control system 400 receives a request for a virtual ticket from virtual ticket device 200. This request may be received via the Internet or via a telephone connection. In response, electronic ticket control system 400 transmits a virtual ticket to virtual ticket device 200. Alternatively, electronic ticket control system 400 may receive a virtual ticket data record for an already issued ticket from a remote ticket agency via the Internet (process step 505).

When the user arrives at public facility 100 to attend the event, virtual ticket device 200 transmits the virtual ticket stored in the virtual ticket device 200 to electronic ticket control system 400 via an entry point terminal. Electronic ticket control system 400 then compares the virtual ticket to the virtual ticket data records 440 stored in memory 430 or database 415 (process step 510). If the virtual ticket is authenticated, electronic ticket control system 400 transmits an authorization message to the entry point terminal and the user is admitted. Otherwise, the user is rejected (process step 515).

During the event, electronic ticket control system 400 may track the location of virtual ticket device 200 via the numerous access points and entry point terminals. If the user attempts to enter a restricted area, such as a private restaurant, a luxury box, or a premium seating area, the entry point terminal at the restricted area transmits the virtual ticket to electronic ticket control system 400. Electronic ticket control system 400 determines from the privileges data whether or not the user is permitted to enter the restricted area (process step 520).

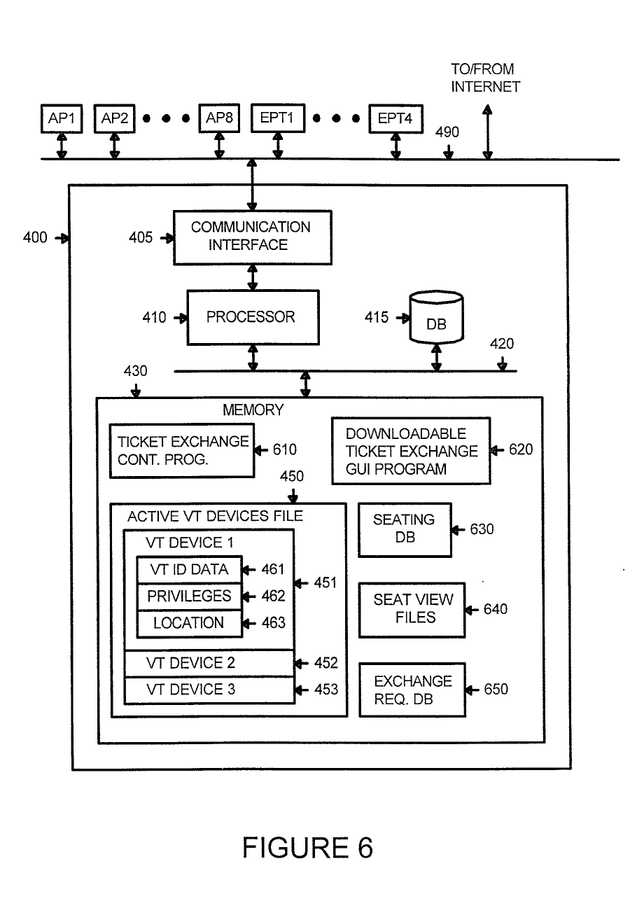

FIG. 6 illustrates selected portions of electronic ticket control system 400 that enables patrons of exemplary public facility 100 to participate in a ticket exchange according to one embodiment of the present invention. In addition to the components illustrated and described above in FIG. 4, electronic ticket control system 400 also comprises a plurality of application programs and data files stored in memory 430 that enable electronic ticket control system 400 to communicate with virtual ticket devices in order to transmit and receive ticket-exchange messages containing ticket-exchange information. Memory 430 stores ticket exchange control program 610, downloadable ticket-exchange graphical user interface (GUI) program 620, seating database (DB) 630, seat view files 640, and exchange request database (DB) 650.

Processor 410 executes program instructions in ticket-exchange control program 610 to enable electronic ticket control system 400 to communicate with virtual ticket devices in order to receive ticket exchange requests. It was noted in the above description of FIG. 2 that downloaded venue applications 214 in virtual ticket device 200 may include one or more applications executed by virtual ticket device 200 when the customer is at public facility 100. These applications may be downloaded before the customer arrives at public facility 100 (e.g., via the Internet) or may be downloaded at public facility 100 via entry point terminals EPT1-EPT4 or access points AP1-AP8. Downloadable ticket-exchange GUI program 620 is one such downloadable program. Ticket-exchange GUI program 620 provides a graphical user interface in virtual ticket device 200 that enables the user to interact with ticket-exchange control program 610. Note that ticket exchange GUI program 620 may not be the exclusive means by which a virtual ticket device interfaces with ticket exchange control program 610, which may also be able in some cases to interface with an off-the-shelf mobile phone or PDA, for example, especially such devices that are already web-accessible. In almost all instances, however, GUI program 620 will enhance the user interface and make participating in the ticket exchange more convenient.

According to an exemplary embodiment of the present invention, the graphical user interface of ticket exchange GUI program 620 may be similar to an e-mail application or to a two-way paging application. In an alternate embodiment of the present invention, the graphical user interface of ticket upgrade GUI program 620 may be similar to a browser application in that ticket exchange opportunities and representative views from the seating area in consideration may be transmitted as HTML data and displayed in a web page format on virtual ticket device 200. Ticket exchange GUI program 620 displays one or more available seats to the user of virtual ticket device 200. Optionally, ticket exchange GUI program 620 may display one or more views of the playing area or stage from the various seats or seating areas. Seat-view files 640 store picture files (e.g., JPEG, BMP, GIF) associated with each seat in public facility 100, which can be viewed by a patron contemplating a ticket exchange. A seat-view image may be an actual still or motion picture, or one intended to be representative of the view from a particular seat or area.

The electronic ticket control system 400 uses virtual ticket device locator program 650 to determine the location of virtual ticket device 200. Generally, the location of virtual ticket device 200 may be determined from the section and seat information associated with the virtual ticket of the user. However, assuming the user roams around, the location of virtual ticket device 200 may be determined by transmitting a message to virtual ticket device 200 prompting the user to enter his or her current location (i.e., nearby section and seat values). In still another embodiment of the present invention, virtual ticket device locator program 650 may determine the location of virtual ticket device 200 according to the location of the access point that is in communication with the virtual ticket device. In particular, in more advanced RF systems, virtual ticket device locator program 650 may use triangulation information captured by two or more access points to determine the location of virtual ticket device 200 without requiring any user input.

In the illustrated embodiment, seating database (DB) 630 is a master list of all seats in public facility 100. Using this list in connection with virtual ticket records 440, processor 410, under control of ticket exchange control program 610, may determine from which seats in public facility 100 have been sold and confirm that a purported exchanger of a ticket is, in fact, the owner. (A procedure for manual ownership verification may also be put in place.) The ownership-verification feature helps to reduce fraud by ensuring that a patron exchanging or selling tickets is actually the patron entitled to use them. Note that the confirmation process may be transparent with respect to the user. When an exchange request message is received, ticket exchange control program 610 directs processor 410 to confirm that the request originated from the ticket's current owner and, if so, store the request information is exchange request database 650. The request message specifies the ticket that is sought to be exchanged, or the ticket that is being sought and the proposed conditions for exchange. Conditions may include a deadline for response, a limitation on which tickets will be accepted in return, or a price term. An exchange request may, of course, relate to more than one electronic ticket, and may include only general conditions of the proposed exchange (for example, “will exchange this [specified] ticket for a similar ticket on Jul. 4, 5, or 6”).

In one embodiment, a patron with a virtual ticket device, properly configured (for example, with GUI program 620), may also request for perusal a listing of ticket exchange requests that have already been made. As there may be a great number of them, presumably the patron would specify certain parameters to limit the listing to those tickets in a particular area of interest, for example on a certain day, in a certain section, or below a certain price. Note that tickets do not have to be so “listed”. For example, one or more patrons may simply reach an agreement for ticket exchange and use their VTDs to cause ownership information to be changed, both in their respective VTD memories 210, and in virtual ticket records 440.

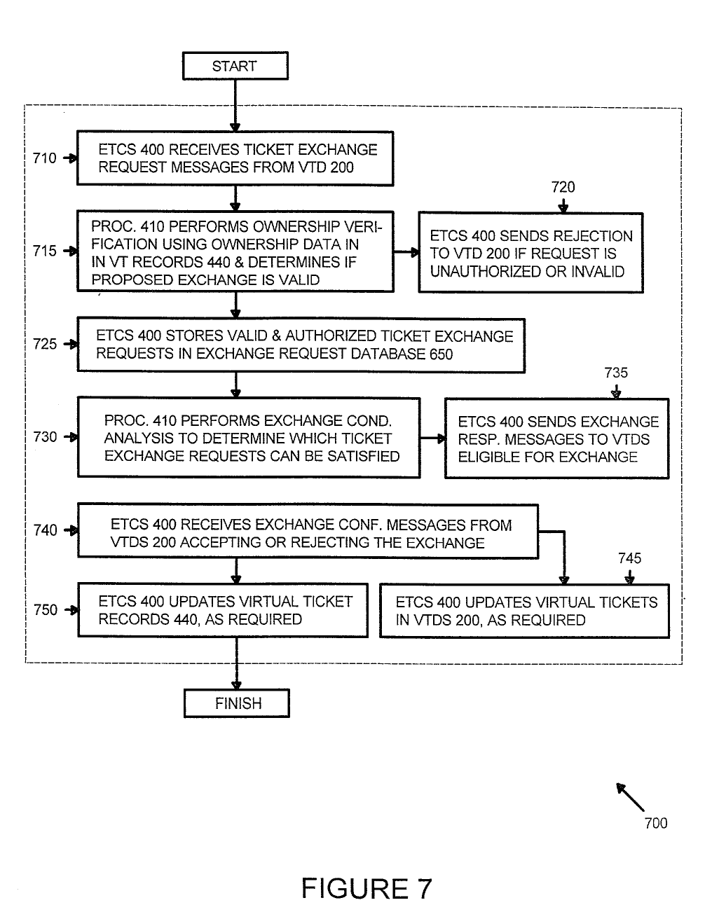

FIG. 7 illustrates a method 700 of enabling a ticket exchange program according to an embodiment of the present invention. In this embodiment, it is presumed at the process step START, the seating database has been populated with a list of public-facility seats, and virtual ticket records 440 with an up-to-date list of which seats have been sold for each upcoming event. “Seat” here is given a broad meaning so as to encompass any admission privilege, including general admission bleachers, “standing-room-only”, or admission to a luxury suite, even if the privilege is not associated with a single unique “chair”. Preferably, each seat is associated with ownership data such that it can be determined (even if not made public) who owns a ticket associated with a seat for a particular event. With regard to virtual tickets, this ownership information also includes an address for communicating with the virtual ticket device storing the ticket, at least when the virtual ticket device is accessible through a public-facility access point or, alternately, through a public telecommunications network. In addition, each seat in seating database 630 is preferably associated with one or more of the images in seat view files 640 so that for any given seat, one or more images representative (if not identical) to the view available from the seat can be retrieved and presented to a patron for consideration. As should be apparent, no one scheme for populating the components of memory 430 with seat information will be preferable in all circumstances, and many variations of the scheme described above may be practiced in accord with the ticket exchange system of the present invention.

Once properly initialized, the electronic ticket control system is ready to receive electronic-ticket exchange messages containing proposective conditions under which the senders will engage in a ticket exchange (process step 710). This may include, for example, specifying a currently-held electronic ticket or tickets and simply announcing a desire to exchange them for other seats in a different area or on a different day. It may also indicate an amount of money (that is, price) that would be satisfactory for an exchange to occur. It may also be fairly general, such as a desire to trade tickets in July for those in August. It must, however, be specific enough to determine which seats—however many—would be affected by the exchange. Received ticket exchange information is analyzed by processor 410 and then stored in exchange request database 650. The analysis consists of determining that the exchange request is both authorized and valid (process step 715). In the illustrated embodiment, the processor 450 of electronic ticket control authorization means performs an ownership verification to ensure any ticket being offered for exchange is, in fact, the property of the patron seeking to exchange it. A valid message contains at least one condition of exchange and is possible to satisfy—a patron cannot, for example, exchange a ticket for an event that has already occurred or seek one for a day on which no event is scheduled.

Improper requests for exchange are rejected and the electronic ticket control system 400 transmits an appropriate notice to the virtual ticket device 200 from which the rejected request originated. Valid and authorized virtual ticket requests are stored in exchange request database 650 (process step 725).

Periodically, ticket exchange control program 610 directs processor 410 to perform a virtual ticket exchange condition analysis to determine which virtual ticket exchange request can be satisfied (process step 730). “Satisfied” means that an exchange of tickets between two virtual ticket devices 200 will satisfy the conditions of exchange in the exchange request messages submitted by both of them. While many exchange requests may satisfy the conditions of more than one request, the two of highest priority are usually paired together first. Priority may be based on order of receipt or some other criteria, such as season-ticket-holder status. In an alternate embodiment, multi-patron exchanges are also enabled. For example, a patron wishing to exchange August tickets for September tickets, will not be satisfied by a request offering July tickets, but given a third request seeking July tickets in trade for September tickets, all three could be satisfied. In this embodiment, many more patrons can be accommodated. Note that this “periodic” analyses could occur according to any desirable schedule, including, for example, daily, every time a request is received, at the facility operator's discretion, or with increasing frequency as the season approaches.

The exchange response message contains, in essence, the terms of a proposed ticket exchange between two (or more) patrons. It gives each patron the opportunity to confirm or reject the proposed exchange, usually by a certain deadline. Optionally, the parties may be given the opportunity to revise their exchange requests, for example, by proposing different price terms or the number of tickets to exchange (step not shown). Any virtual ticket device not responding to an exchange response message within a predetermined time period is considered to have rejected the proposed exchange. Preferably, only one exchange for each eligible ticket exchange request is contemplated at any given time. In other words, an exchange response message is not sent to every request that could be the condition of a proposed exchange. Alternately, a response message may contain more than one different, but satisfactory choice (“tickes in August” could be for the 15^{th} or 25^{th}) At some point, an exchange confirmation is received from the virtual ticket devices (or by alternate means. In an alternate embodiment, a patron may specify a different type of notification.) (process step 740). If all parties to the exchange respond positively, the exchange is executed by updating the electronic tickets stored in the virtual ticket device to reflect the results of the exchange 745. The virtual ticket records 440 are normally also updated to reflect the new ownership status of each ticket (process step 750). If either party rejects the proposed exchange, of course, no updates occur, and each now-retracted exchange request is deleted. That is, the request associated with a negative response—patrons responding positively are retained in the database for further consideration.

As all electronic ticket exchanges are performed by the electronic ticket control system, the facility operator may exert control over the exchanges made and charge (or waive, as the case may be) a service fee for facilitating the exchange. The operator is also able to monitor exchanges to try and prevent fraudulent or sharp practices. For example, the system may watch for price exchanges (sales) exceeding a certain price, review reports of patrons that exchange very actively, or take note when a particular virtual ticket device 200 repeatedly requests unauthorized or invalid exchanges. And of course, the operator can verify that the tickets offered for exchange are actually owned by the offerer.

In one embodiment, owners of paper tickets may also exchange their tickets at facility outlet for electronic tickets provided a suitable ticket device 200 is available. For example, the facility operator may make a terminal in communication with the ticket exchange system publicly accessible, either at the facility or at a remote location. The terminal may be able to receive an issued paper ticket and convert it to a virtual ticket. The terminal would then allow the user to participate in a virtual ticket exchange by submitting a request, etc. (The user in this instance may well request an alternate mode of response, such as an email message.) Even if the terminal user does not have a virtual ticket device, a unique PIN number could be issued so that the user could later use it to obtain a replacement ticket—one that is either identical to the original ticket or a ticket representing a different admission privilege that has been obtained using the electronic ticket exchange system. The large facility owner may also provide a publicly-available listing of tickets being offered for exchange, e.g., on a web site.

Two patrons wishing to conduct a specific ticket exchange may also be allowed to simplify by (both) informing electronic ticket control system 400, whereupon the requested exchange takes place without listing.

The operators of large facilities may increase revenues as well by facilitating the lawful exchange of tickets. Where their revenue was limited previously to the purchase price of the ticket, it can be increased if tickets are exchangeable by one of several methods. First, marketable tickets may be more valuable at the outset, and in any event can be no less valuable than non-exchangeable tickets. Second, where exchange is anticipated or even encouraged, a premium for an exchangeable ticket may be charged, perhaps offset by a reduction in price for a purely electronic purchase. Alternately, the owner-operator of a large public facility may charge a premium only when a ticket is actually exchanged, perhaps by adding a service charge based on the resale price.

To enhance service-fee revenues associated with the ticket exchange system, an operator may send messages to patrons, through their virtual ticket devices or otherwise, suggesting that they consider the service. The suggestion may include, where applicable, a notice that tickets such as the one held in the virtual ticket device are commanding favorable terms of exchange. In some instances, the facility operator may even offer an incentive for participating in the exchange program. This incentive could, of course, be targeted to one or a selected group of virtual ticket devices.

Although the present invention has been described in detail, those skilled in the art should understand that they can make various changes, substitutions and alterations herein without departing from the spirit and scope of the invention in its broadest form.

What is claimed is:

1. A method of doing business, comprising:
providing an electronic ticket control system for issuing virtual tickets to public-facility patrons through virtual ticket devices;
receiving virtual ticket exchange requests from a plurality of virtual ticket devices;
storing the exchange requests in an exchange request database;
analyzing the exchange requests to determine if any are eligible for exchange;
sending an exchange notification message to the virtual ticket devices associated with at least one eligible exchange;
receiving an exchange confirmation message from the eligible virtual ticket devices associated with the at least one exchange; and
updating the virtual tickets when all virtual ticket devices associated with the at least one exchange respond affirmatively.

2. The method of doing business of claim 1, further comprising the step of maintaining an ownership database for storing ownership information related to issued virtual tickets.

3. The method of doing business of claim 2, further comprising the step of updating the ticket ownership database to reflect a change in ownership resulting from a ticket exchange.

4. The method of doing business of claim 1, further comprising the step of, before storing the exchange request in the database, confirming ownership of any virtual tickets offered for exchange.

5. The method of doing business of claim 1, wherein the step of analyzing includes comparing the exchange conditions of more than two exchange requests in order to determine if more than two requests can be satisfied in the same exchange transaction.

6. The method of doing business of claim 1, further comprising the step of providing a downloadable virtual ticket exchange user-interface program for downloading by patrons onto virtual ticket devices and use in exchanging virtual tickets through the electronic ticket control system.

7. The method of doing business of claim 1, further comprising the step of performing a validity check with respect to the received request before storing it in the exchange request database.

8. The method of doing business of claim 1, further comprising the steps of:
performing a validity check on ticket exchange requests stored in the database; and
deleting stored requests that are determined to be invalid.

9. The method of doing business of claim 1, further comprising the step of sending a message to at least one virtual ticket device, the message containing information relating to virtual ticket exchange requests.

10. The method of doing business of claim 9, wherein the information relating to virtual ticket exchange requests includes a notification that a request has been received that corresponds to the virtual ticket stored on the virtual ticket device.

11. The method of doing business of claim 9 wherein the information relating to virtual ticket requests further includes an incentive for offering for exchange the ticket held on the virtual ticket device.

12. The method of doing business of claim 1 further comprising the step of charging a service fee to customers for brokering the exchange requests.

13. The method of doing business of claim 1 further comprising the steps of charhing the account of a first patron an amount for the ticket exchange; and
crediting the account of a second patron a corresponding amount for the ticket exchange.

14. The method of doing business of claim 1 wherein at least some of the exchange requests include information that a patron is either willing to pay for or requires payment for a ticket exchange.

15. The method of doing business of claim 14 further comprising the steps of charging the account of a first patron an amount for the ticket exchange; and
crediting the account of a second patron a corresponding amount for the ticket exchange.

16. An electronic ticket exchange system for use by public-facility patrons having virtual tickets stored on virtual ticket devices that are capable of communicating with the ticket exchange system, said ticket exchange system comprising:
an exchange request database for storing information related to exchange requests received from virtual ticket devices;
a processor in communication with the exchange request database;
a ticket-exchange control program for directing the processor to compare exchange requests stored on the exchange request database to determine if an exchange is possible.

17. The system of claim 16, further comprising a seat-view image database for storing images that can be transmitted to a virtual ticket device.

18. The ticket exchange system of claim 16, wherein the ticket control program also directs the processor to confirm the validity of virtual ticket exchange requests.

19. The ticket exchange system of claim 16, further comprising a downloadable user-interface program.

20. The ticket exchange system of claim 16, further comprising an ownership database for storing information related to public-facility virtual ticket ownership.

21. The ticket exchange system of claim 20, wherein the ticket exchange control program directs the processor to confirm the ownership of any virtual ticket offered for exchange.

22. The ticket exchange system of claim 16, further comprising a terminal in communication with the ticket exchange system that accepts public-facility tickets that are not virtual tickets and converts them to virtual tickets for possible exchange.

23. The ticket exchange system of claim 22, wherein the terminal reissues a second non-virtual ticket in exchange for a first non-virtual ticket that has been successfully exchanged.

24. A method of doing business comprising:
electronically brokering the exchange of seats between patrons at a public facility.

25. The method of claim 24 comprising the step of providing the patrons images of views from seats available for exchange.

26. The method of claim 25 further comprising charging at least one of the patrons a service fee for the exchange.

27. The method of claim 26 wherein the service fee is based upon the selling price of the exchanged tickets.

28. The method of claim 24 comprising the step of prioritizing ticket exchange requests.
